(19) United States
(12) Patent Application Publication
(10) Pub. No.: US 2022/0404032 A1
(43) Pub. Date: Dec. 22, 2022

(54) COOKING SYSTEM AND METHOD OF OPERATION

(71) Applicant: Miele & Cie. KG, Guetersloh (DE)

(72) Inventors: Marco Wiechert, Soest (DE); Ole Behrens, Arnsberg (DE); Ingo Huester, Arnsberg (DE); Artur Geist, Arnsberg (DE); Bogdan Jagos, Eslohe (DE); Julian Hasse, Arnsberg (DE)

(21) Appl. No.: 17/844,062

(22) Filed: Jun. 20, 2022

(30) Foreign Application Priority Data
Jun. 21, 2021 (DE) 10 2021 115 928.8

(51) Int. Cl. F24C 15/20

(52) U.S. Cl. CPC F24C 15/2085; H05B 2213/06

(57) ABSTRACT

A cooking system includes: at least one control device; at least one extractor device; at least one cookware item; and at least one stovetop. The at least one extractor device includes at least one movable vapor screen device having at least one suction opening in operative connection with at least one fan device. The at least one stovetop device includes at least one placement device for placing cookware and at least one heating device for heating cookware. The at least one movable vapor screen device is movable to at least two operating positions with at least one different extension height in each case. The cookware includes at least one transmitting/receiving device for transmitting at least one signal with at least one identification signature to at least the control device, by which the at least one cookware item is identifiable. The at least one control device has a communications device.

### CROSS-REFERENCE TO PRIOR APPLICATION

Priority is claimed to German Patent Application No. DE 10 2021 115 928.8, filed on Jun. 21, 2021, the entire disclosure of which is hereby incorporated by reference herein.

### FIELD

The present invention relates to a cooking system comprising at least one control device, at least one extractor device, and at least one stovetop device. The extractor device comprises at least one movable vapor screen device with at least one suction opening in operative connection with at least one fan device. The stovetop device comprises at least one placement device for placing cookware and at least one heating device for heating cookware. The vapor screen device can be moved to at least two operating positions with at least one different extension height in each case. The present invention further relates to a method for operating such a cooking system.

### BACKGROUND

A large number of cooking systems have become known in which an extractor device such as, for example, an extractor hood and/or a downdraft fan is installed above and/or around a stovetop in order to suction off the fatty vapor rising up during cooking and thus avoid soiling of the kitchen elements as well as unpleasant odor development. For this purpose, the fatty vapor and/or the air which rises above a stovetop is typically sucked into a suction opening by at least one fan, freed from fatty components and odors, and then, depending upon the configuration of the extractor device, passed on in a recirculated and/or exhaust air operation.

Cooking systems in which one or more so-called downdraft fans are arranged around a stovetop or are integrated into a stovetop and guide the sucked-in vapor and/or the air downwards under the stovetop are typically used when there is no space for installation above the stovetop or where visual aspects speak against such an installation.

Normally, at least one downdraft fan of such a cooking system comprises a vapor screen which, due to its at least slightly elevated arrangement above the stovetop—in particular, due to an elevated arrangement of the suction opening—allows for better absorption or better suction of vapors. In known cooking systems, such a vapor screen can be designed to be movable so that the height and/or position of the suction opening can be adapted to the present cooking situation—in particular, to the height of a cookware item—which allows for a particularly effective and even more powerful extraction of vapors.

In known cooking systems, a height and/or position of the suction opening that is preferred in the present cooking situation must often be set manually by a user, and/or the height of a cookware item must be measured by means of sensors before the vapor screen can be automatically moved to such a height.

However, manual adjustment is uncomfortable, and an incorrectly set height reduces the efficiency and may thus increase the energy consumption—in particular, when a higher operating stage is used to compensate for the situation.

Publication DE 10 2018 200 764 A1 discloses measuring the height with sensors, but this is technically difficult and may be disturbed if a wrong height is detected by dirty sensors and/or a special design, and/or if, for example in the case of optical sensors, other objects and/or the user hinder and/or obstruct the free view of the cookware.

### SUMMARY

In an embodiment, the present invention provides a cooking system, comprising: at least one control device; at least one extractor device; at least one cookware item; and at least one stovetop device, wherein the at least one extractor device comprises at least one movable vapor screen device having at least one suction opening in operative connection with at least one fan device, wherein the at least one stovetop device comprises at least one placement device configured to place cookware and at least one heating device configured to heat cookware, wherein the at least one movable vapor screen device is movable to at least two operating positions with at least one different extension height in each case, wherein the at least one cookware item comprises at least one transmitting/receiving device configured to transmit at least one signal with at least one identification signature to at least the control device, by which the at least one cookware item is identifiable, wherein the at least one control device has a communications device, wherein the at least one control device is configured to determine an identity of the at least one cookware item by the at least one identification signature, and wherein the at least one control device is configured to automatically move the at least one movable vapor screen device to the operating position assigned to the identity of the at least one cookware item and move the at least one movable vapor screen device to the operating position assigned to the identified at least one cookware item.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a purely schematic illustration of an exemplary embodiment of a cooking system according to the invention in a sectional view from the side;

FIG. 2 is a purely schematic illustration of a further exemplary embodiment of a cooking system according to the invention in a sectional view from the side;

FIG. 3 is a purely schematic illustration of another exemplary embodiment of a cooking system according to the invention in a sectional view from the side; and

FIG. 4 is a purely schematic illustration of a further exemplary embodiment of a cooking system according to the invention in a sectional view from the side.

### DETAILED DESCRIPTION

In an embodiment, the present invention provides a cooking system which allows for a particularly user-friendly and reliable adjustment of an advantageous extension height of a vapor screen device.

The cooking system according to the invention in embodiment comprises at least one control device, at least one extractor device, and at least one stovetop device. The extractor device comprises at least one movable vapor screen device with at least one suction opening in operative connection with at least one fan device. The stovetop device comprises at least one placement device for placing cookware and at least one heating device for heating cookware. The vapor screen device can be moved to at least two operating positions with at least one different extension height in each case. The control device is suitable and designed for identifying at least one cookware item, and the vapor screen device can be moved to the operating position assigned to the identified cookware item.

The control device is preferably suitable and designed for determining at least one identity of a cookware item, and the vapor screen device can preferably be moved—in particular, automatically moved—to at least an operating position assigned to the identity of the cookware item.

In advantageous developments, the extractor device comprises at least one drive device, by means of which the vapor screen device can be moved automatically.

The control device is preferably suitable and designed for identifying, or for determining the identity of, at least one cookware item placed on the placement device.

The control device is preferably suitable and designed for controlling the drive device so that the vapor screen device can be moved automatically to at least the operating position assigned to the identified cooking item.

The extractor device is in particular a downdraft fan, which is preferably suitable and designed for sucking in air and/or vapor rising above the placement device and/or above a countertop into the suction opening and for guiding it, in particular, downwards, under the placement device and/or the countertop and towards the fan device.

In expedient developments, the extractor device is integrated at least in sections into the placement surface and/or the countertop, or is accommodated in the same.

In advantageous developments, the stovetop device is integrated at least in sections into the placement surface and/or the countertop, or is accommodated in the same.

The operating position is in particular a position in which the vapor screen device and in particular the suction opening are arranged substantially above the placement device and/or the countertop. In particular, in the operating position, air and/or vapor can be sucked from the placement device and/or from the countertop into the suction opening.

In expedient developments, the vapor screen device can be moved at least to a resting position in which the vapor screen device and in particular the suction opening are arranged substantially below the placement device and/or the countertop. In the resting position, an upper wall of the vapor screen device is preferably arranged substantially flush with the placement device and/or with the countertop.

The extension height is in particular a height of an upper wall of the vapor screen device above the placement device and/or the countertop. Preferably, however, the extension height can also correspond to a height of the suction opening above the placement device and/or the countertop.

Preferably, the vapor screen device can be moved between at least one resting position and at least two operating positions with at least one different extension height in each case.

In advantageous developments, the extractor device—in particular, the vapor screen device—comprises at least one filter device for filtering the sucked-in air or the sucked-in vapor.

In expedient developments, the suction opening is arranged on or accommodated in an upper portion of the vapor screen device. Preferably, the suction opening is arranged on a front portion, facing the placement device, of the vapor screen device. In particular, the vapor screen device is substantially designed to be cuboid-shaped.

The cookware item is in particular a container for preparing food or meals, such as, for example, a pot, a pan, a casserole, a cooking dish, and/or a similarly suitable device. The cookware item preferably comprises at least a bottom and at least a wall, wherein, in particular, the bottom and wall limit or delimit a receiving volume for receiving foods or foodstuff and/or meals. The cookware is preferably a smart cookware item comprising, in particular, at least a sensor device and/or at least a transmitting/receiving device.

The cooking system according to the invention offers many advantages. One major advantage is that the control device is suitable and designed for identifying at least one cookware item, and that the vapor screen device can be moved to the operating position assigned to the identified cookware item.

This allows for a particularly user-friendly and comfortable adjustment of an advantageous extension height of a vapor screen device. If the identity of a cookware item is known, the vapor screen device can be moved to an extension height which is particularly advantageous when cooking with this cookware item or during the use of this cookware item. For example, the vapor screen device can be moved to an operating position in which the suction opening is arranged in the vicinity of and in particular at largely the same height as an upper edge of a cookware item placed on the placement device, so that rising vapor and/or air can be suctioned off into the suction opening and to the fan device in a particularly effective and powerful manner, or even in an optimal manner.

As a result, the cooking system according to the invention allows not only for a particularly energy-efficient or, in particular, even energy-saving operation, but also for particularly comfortable use, because manual setting and/or adjustment of the extension height of the vapor screen by a user in frequently changing cooking situations is largely unnecessary.

Since the control device is suitable and designed for identifying at least one cookware item, it is possible to largely dispense with sensors used, for example, to detect the height of a cookware item. Nevertheless, a particularly user-friendly and above all robust system is provided. This is because, in the vicinity of a stovetop device, sensors become soiled quickly by grease and other dirt, as a result of which not only is their function impaired, but also their service life can be considerably reduced. A regular and often difficult cleaning and/or maintenance of sensors is thus obviated.

Preferably, at least one operating position assigned to the identity of a cookware item is stored in the control device.

In expedient developments, at least one operating position assigned to the identity of a cookware item is stored by the control device.

Preferably, each operating position has a different extension height.

Particularly preferably, at least one operating position assigned to the identity of a cookware item can be set by a user. As a result, a user can set an operating position for a cookware item having a particular identity, which operating position corresponds to his wishes, requirements, and/or demands and is thus particularly user-friendly, so that, when using the cookware item having this particular identity, the vapor screen device can be automatically moved to the operating position corresponding to the user's desires, requirements, and/or demands.

In particular, an operating position assigned by a user to an identity of a cookware item is stored in the control device.

In advantageous developments, the extension height of at least one operating position can be set by a user. Depending upon the task and configuration, the extension height of at least one operating position can preferably be predetermined.

In expedient developments, the extension height of the vapor screen device can be set by a user. In particular, the extension height of a vapor screen device moved to an operating position can be changed by a user.

Preferably, an operating position, which is repeatedly set by a user when a particular cookware item is used, is automatically assigned to the identity of this particular cookware item.

Preferably, the control device is suitable and designed for automatically storing an operating position set repeatedly by a user when using a particular cookware item and for assigning it to the identity of this particular cookware item.

In expedient developments, at least one cookware item can be identified by means of at least one recipe sequence program.

In this case, a recipe sequence program is in particular a control program, an automatic program, and/or a cooking recipe. Preferably, the recipe sequence program is provided by an operating device and/or a control element of the stovetop device. Depending upon the task and configuration, the recipe sequence program can also be provided by the control device.

In advantageous developments, at least the identity of one cookware item can be determined by means of at least one recipe sequence program.

The control device preferably determines the identity of the cookware item from a sequence program or cooking recipe selectable and/or selected by a user. In particular, the identity of a cookware item is predetermined by a recipe sequence program.

In expedient developments, the sequence program or cooking recipe can be provided by an operating device. The operating device can, in particular, be a mobile operating device, such as a smartphone, a tablet computer, and/or a cloud or a cloud service.

Particularly preferably, the cookware item is suitable and designed for transmitting at least one signal with at least one identification signature to at least the control device, by means of which the at least one cookware item can be identified.

In particular, at least the identity of the cookware item can be determined by means of the at least one signal. The cookware item preferably comprises at least one transmitting/receiving device which is suitable and designed for transmitting at least one signal with an identification signature.

Preferably, the at least one signal is transmitted via a WLAN, Bluetooth, ZigBee, NFC, and/or similar communications connection.

Preferably, the control device and/or the stovetop device comprises at least one communications device by means of which the at least one signal can be received. Depending upon the task and configuration, a communications device preferably can also transmit signals.

The control device is preferably suitable and designed for identifying the cookware item from at least one parameter of said cookware item.

Here, a parameter is in particular a dimension of the cookware item, such as, for example, a diameter of the bottom, a diameter and/or a circumference of the wall, and/or a height of the cookware item. Depending upon the task and configuration, the parameter can preferably also be a shape or a spatial configuration of the cookware item and/or correspond to a frequency of use of a cookware item by a user.

The control device preferably identifies a cookware item placed on the placement device by means of at least one parameter of said cookware item.

In advantageous developments, the power consumed by at least one heating device can be determined so that the control device can draw conclusions about the identity of at least one cookware item from at least the power consumed.

Here, power consumed means in particular a power used and/or taken up by cookware.

Preferably, the control device can draw conclusions about the identity of at least one cookware item, located, in particular, on the placement device above the heating device, from at least the power consumed.

In expedient developments, the control device and/or the stovetop device determines at least a diameter—preferably of the bottom of a cookware item located in particular on the placement device above the heating device—from at least a power used by the heating device. In particular, the control device can draw conclusions about the identity of a cookware item or can identify a cookware item from at least one determined diameter.

In the method according to the invention for operating a cooking system, as described above, the vapor screen device is automatically moved to the operating position assigned to the identity of a cookware item.

Preferably, the vapor screen device is automatically moved to at least one operating position assigned to an identified cookware item.

The method according to the invention for operating a cooking system also has the advantages of a cooking system according to the invention.

In particular, the method for operating a cooking system makes it possible to move the vapor screen device to the operating position assigned to the identity of a cookware item, so that an effective and powerful suction of vapors rising above the stovetop device is made possible in a particularly user-friendly manner.

The control device preferably identifies at least one cookware item—in particular, one placed on the placement device of the stovetop device.

The control device preferably determines at least one identity of at least one cookware item—in particular, one placed on the placement device.

The control device preferably identifies the identity of several cookware items—in particular, those placed on the placement device.

In advantageous developments, the at least one cookware item transmits at least one signal with at least one identification signature to the control device, and the control device identifies this cookware item by means of the at least one identification signature.

In expedient developments, at least one cookware item transmits at least one signal with at least one identification signature to the control device, and the control device determines the identity of the at least one cookware item by means of the at least one identification signature.

The control device preferably determines the identity of at least one cookware item, placed in particular on the placement device, from at least one identification signature.

Preferably, the at least one signal is transmitted by the transmitting/receiving device via a WLAN, Bluetooth, ZigBee, NFC, and/or similar communications connection.

Particularly preferably, the control device identifies at least one cookware item by means of at least one recipe sequence program.

In this case, a recipe sequence program is in particular a control program, an automatic program, and/or a cooking recipe. Preferably, the recipe sequence program is provided by an operating device and/or a control element of the stovetop device. Depending upon the task and configuration, the recipe sequence program can also be provided by the control device.

In particular, a sequence program or a cooking recipe is provided by an operating device. An operating device can, in particular, be a mobile operating device, such as a smartphone, a tablet computer, and/or a cloud or a cloud service, or can be provided by such a device.

The control device preferably determines the identity of at least one cookware item from at least one sequence program or cooking recipe, selected in particular by a user.

In particular, the identity of a cookware item is predetermined by a recipe sequence program.

In expedient developments, a user selects and/or determines a cookware item or an identity of a cookware item which is used in the recipe sequence program and/or to which the recipe sequence program is geared. Particularly in cases where a user uses a cookware item that deviates from the one provided in the recipe sequence program, the extension height can preferably be adapted to the of the cookware item used by the user.

The control device preferably draws conclusions about the identity of the cookware item from at least one parameter of said cookware item.

Here, a parameter is in particular a dimension of the cookware item, such as, for example, a diameter of the bottom, a diameter, and/or a circumference of the wall. Depending upon the task and configuration, the parameter can preferably also be a shape of the cookware item and/or correspond to a frequency of use of a cookware item by a user.

In expedient developments, the control device and/or the stovetop device determines the power consumed by at least one heating device, and the control device draws conclusions about the identity of at least one cookware item from at least the power consumed.

Here, power consumed means in particular a power used and/or taken up by the cookware.

Preferably, the control device draws conclusions about the intensity of at least one cookware item placed on the placement device from at least the power consumed by at least one heating device.

Particularly preferably, the vapor screen device is moved to an intermediate position if the identity of the cookware item cannot be clearly determined.

Here, an intermediate position is in particular a position having an extension height that is between the extension heights of the at least two operating positions.

Here, the identity of the cookware item, in particular, cannot be clearly determined if, for example, two cookware items placed on the placement device have the same diameter, and the diameter of one cookware item is used as a parameter to identify the cookware placed on the placement device.

In expedient developments, the vapor screen device is moved to an intermediate position if a plurality of cookware items are identified, the identities of which are assigned to at least two different operating positions, each having a different extension height. In particular, the vapor screen device is then preferably moved into an operating position which has an extension height smaller than the height of a first identified cookware item and greater than the height of a second identified cookware item. The height of the first identified cookware item is preferably greater than the height of the second identified cookware item. This embodiment is particularly expedient when a roasting process is carried out at one of the cooking points.

If several cooking items are identified, the identities of which are assigned to at least two different operating positions, each having a different extension height, an alternative embodiment provides for the vapor screen device to then be preferably moved to an operating position equal to or greater than the extension height of the higher of the two identified cookware items. A particular embodiment of this alternative provides for the vapor screen device to then be moved to an operating position equal to or greater than the sum of the heights of the two identified cookware items or equal to or greater than twice the mean value of the heights of the two identified cookware items. In any case, the vapor screen device is moved to an operating position equal to or smaller than the maximum extension height of the device. This embodiment is particularly expedient when a cooking process—in particular, with strong steam development—is carried out simultaneously at several cooking points.

Further advantages and features of the present invention result from the exemplary embodiments, which are explained below with reference to the accompanying figures.

FIG. 1 shows a purely schematic illustration of an exemplary embodiment of a cooking system 1 according to the invention in a sectional view from the side.

The cooking system 1 here comprises a control device 2, a stovetop device 4, and an extractor device 3 designed here as a downdraft fan.

The stovetop device 4, which here has a placement device 8 for placing cookware items 9 and a heating device 10 for heating cookware items 9 placed thereon, is here integrated or accommodated in sections in a countertop 22.

In the exemplary embodiment shown here, a cookware item 9 is placed on the placement device 8 of the stovetop device 4. Here, the cookware item 9, which is designed here as a pot, has a height 19 and a diameter 18.

The extractor device 3 here comprises a fan device and a movable vapor screen device 5 with a filter device 15 and with a suction opening 6 in operative connection with the fan device 7. The suction opening 6 is here accommodated on an upper portion, facing the stovetop device 4, of the vapor screen device 5, so that any vapors rising from the cookware item 9 and/or from the stovetop device 4 during cooking can be sucked into the suction opening 6 and discharged downwards through the filter device 15 and to the fan device 7.

In the exemplary embodiment shown here, the vapor screen device 5 can be automatically moved by means of a drive device in two operating positions 11, 12 with a different extension height 13, 14 in each case. In the operating position 11, the vapor screen device 5 here has an extension height 13 at which the suction opening 6 is located substantially on a level with the upper edge of the cookware item 9 placed on the placement device 8. Thus, the height 19 of the cookware item 9 here largely corresponds to the height at which the suction opening 6 is arranged in the operating position 11. In the operating position 12, which is indicated here by dashed lines, the vapor screen device 5 has an extension height 14 at which the suction opening 6 is substantially located at a height above the upper edge of the cookware item 9 placed on the placement device 8.

In the exemplary embodiment shown here, the vapor screen device 5 can additionally be moved to an intermediate position 21 in which the extension height of the vapor screen device is smaller than the extension height 14 of the operating position 12 and greater than the extension height 13 of the operating position 11. Furthermore, the vapor screen device 5 can be moved here to a resting position in which the vapor screen device 5 is arranged substantially below the countertop 22. Depending upon the task and configuration, the vapor screen device can also be moved largely continuously by means of the drive device.

In the exemplary embodiment shown here, several operating positions 11, 12, each with a different extension height 13, 14 and each assigned to at least one identity of a cookware item 9, are stored or placed into memory on the control device 2. Depending upon the task and embodiment, the assignment of an identity of a cookware item 9 or of a particular cookware item 9 to an operating position 11, 12 can be carried out manually by a user, and/or the assignment of an identity of a cookware item 9 to an operating position 12, 13 can be predetermined. Here, it is also possible for the control device to automatically recognize an operating position 11, 12 which is set repeatedly by a user when using a particular cookware 9 item, and to assign this operating position to the identity of this particular cookware item 9. Depending upon the task and embodiment, different cookware items 9, i.e., cookware items 9 with different identities, can be assigned to one or the same operating position 11, 12, or every identity of a cookware item 9 can be assigned a different or separate operating position 11, 12.

Here, the control device is suitable and designed for detecting the identity of a cookware item 9 and for controlling the drive device. Thus, according to a method according to the invention for operating a cooking system 1, the vapor screen device 5 can be moved to the operating position 11, 12 assigned to the determined identity of a cookware item 9.

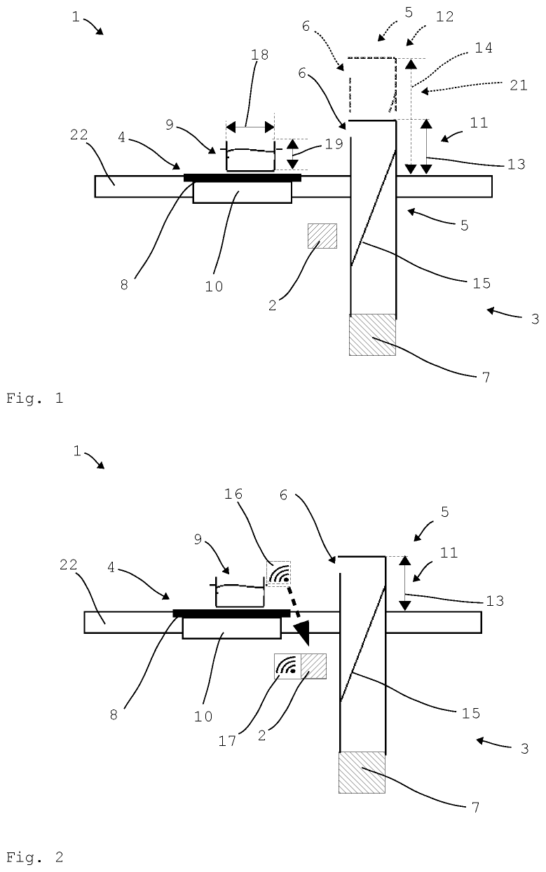

FIG. 2 shows a purely schematic illustration of a further exemplary embodiment of a cooking system 1 according to the invention in a sectional view from the side.

The exemplary embodiment shown here comprises all embodiments of the cooking system 1 from FIG. 1; however, here, the control device 2 has a communications device 17, and a cookware item 9 placed here on the placement device 8 comprises a transmitting/receiving device 16, which is here indicated purely schematically.

The communications device 17 and the transmitting/receiving device 16 are here suitable and designed for communicating, at least temporarily, wirelessly via a Bluetooth connection. Depending upon the task and configuration, communication between the communications device 17 and the transmitting/receiving device 16 can also take place by means of a similarly suitable communications connection, such as a Wlan, ZigBee, and/or NFC connection. It is also possible for the transmitting/receiving device 16 to be suitable and designed only for transmitting and for the communications device 17 to be suitable and designed only for receiving a signal.

Thus, in the exemplary embodiment shown here, the cookware item 9 placed here on the placement device 8 can transmit a signal with an identification signature to the control device 2.

Hence, according to a method for operating a cooking system 1, the control device 2 can identify the placed cookware item 9 by means of the identification signature, and the vapor screen device 5 can be automatically moved to an operating position 11, 12 assigned to the identity of this particular cookware item 9 and stored here on the control device 2.

In the exemplary embodiment shown here, the vapor screen device 5 is moved to an operating position 11, having an extension height 13, which is assigned to the identity of the cookware item 9 placed here. In the operating position 11 shown here, the suction opening 6 is arranged largely at the height 19 of the cookware item 9 placed here on the placement device 8, i.e., the suction opening 6 is located substantially on a level with the upper edge of the cookware item 9. Thus, the extractor device 3 can suck in a vapor, which rises from the cookware item during, for example, cooking, into the suction opening 6 in a particularly effective and powerful manner and can guide said vapor downwards through the filter device 15 and to the fan device 7.

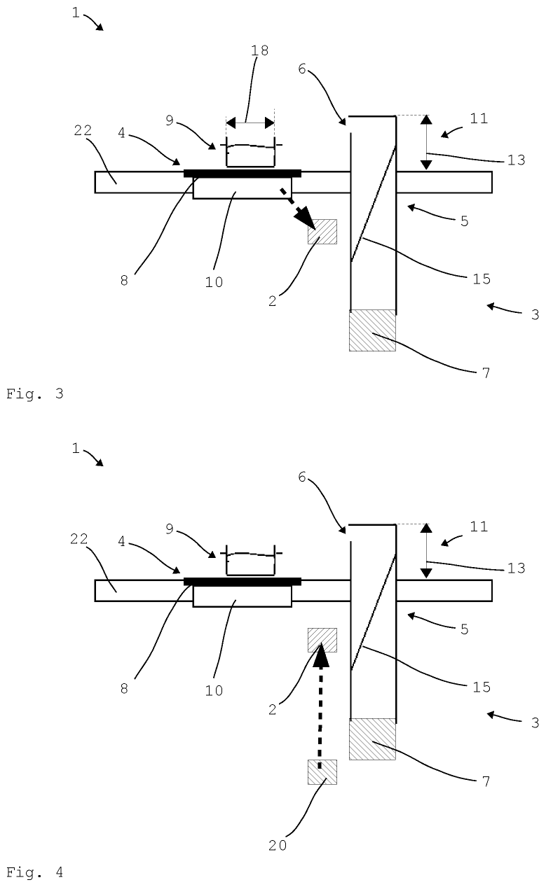

FIG. 3 shows a purely schematic illustration of a different exemplary embodiment of a cooking system 1 according to the invention in a sectional view from the side.

The exemplary embodiment shown here comprises all embodiments of the cooking system 1 from FIG. 1. As in FIG. 1, the extractor device 3 here comprises a vapor screen device 5 with a suction opening 6 in operative connection with a fan device 7, and the stovetop device 4 here comprises a placement device 8 for placing cookware items 9 and a heating device 10 for heating the cookware items 9 placed on the placement device.

In the exemplary embodiment shown here, the control device 2 is suitable and designed for identifying a particular cookware item 9 from at least one parameter of said cookware item 9. To this end, the stovetop device 4 is suitable and designed for determining the power consumed by the heating device 10 or the power used for heating the cookware item 9 which has been placed on the placement device 8, and for transmitting it to the control device 2. In the exemplary embodiment shown here, the power consumed is transmitted via a cable connection between the stovetop device 4 and the control device 2. Depending upon the task and embodiment, transmission of the consumed or current power can take place wirelessly.

Thus, according to a method for operating a cooking system 1, the control device 2 can draw conclusions about the identity of the cookware item 9 placed here on the placement device 8 from the power consumed, in that the control device here infers the diameter 18 of the placed cookware item 9 from the power consumed or in that it determines the diameter 18 of the cookware item 9, and the vapor screen device 5 is automatically moved to an operating position 11 assigned to the identity of this cookware item 9 and stored here on the control device 2.

Depending upon the task and embodiment, the control device can also draw conclusions about the identity of the placed cookware item from another parameter of the cookware item.

If, in the exemplary embodiment shown here, the control device 2 cannot clearly identify the cookware item 9 placed on the placement device 8 because, for example, two or more cookware items have the same diameter or several cookware items are identified and their identities are assigned to at least two different operating positions, then the vapor screen device 5 is moved to an intermediate position 21 or the greatest of the determined extension heights.

FIG. 4 shows a purely schematic illustration of a further exemplary embodiment of a cooking system 1 according to the invention in a sectional view from the side.

The exemplary embodiment shown here comprises all embodiments of the cooking system 1 from FIG. 1. As in FIG. 1, the cooking system comprises a control device 2, an extractor device 3 with a movable vapor screen device 5, and a stovetop device 4 with a placement device 8 for placing cookware 9 and a heating device 10 for heating the cookware 9 placed. Here, the control device is suitable and designed for identifying a cookware item 9 by means of a recipe sequence program.

In the exemplary embodiment shown here, such a sequence program or cooking recipe is provided by an operating device 20. Depending upon the task and embodiment, the operating device 20 can be designed to be stationary and/or mobile. For example, the operating device 20 can be provided so as to be stationary by the stovetop device or the extractor device 3 and/or mobile by, for example, a smartphone, a tablet computer, or a cloud service.

The sequence program or cooking recipe here contains information about the identity of the cookware 9 to be used during a sequence of the recipe sequence program or cooking recipe. Depending upon the task and embodiment, however, a user can also select a particular cookware item 9 or set an identity of a cookware item 9 in the recipe sequence program—for example, according to the desired amount of food to be prepared.

In the exemplary embodiment shown here, the sequence program or cooking recipe is selected by a user on the operating device 20. The operating device 20 here transmits the identity of the cookware item 9 predetermined by the recipe sequence program to the control device 2.

Thus, according to a method for operating a cooking system 1, the control device 2 can identify the cookware item 9 placed here on the placement device 8 by means of a recipe sequence program, and the vapor screen device 5 can be automatically moved to an operating position 11 assigned to the identity of this particular cookware item 9 and stored here on the control device 2.

In the exemplary embodiment shown here, the vapor screen device 5 is moved to an operating position 11, having an extension height 13, which is assigned to the identity of the cookware item 9 placed here. In the operating position 11 shown here, the suction opening 6 is arranged largely at the height 19 of the cookware item 9 placed here on the placement device 8, i.e., the suction opening 6 is located substantially on a level with the upper edge of the cookware item 9. Thus, the extractor device 3 can suck in a vapor, which rises from the cookware item during, for example, cooking, into the suction opening 6 in a particularly effective and powerful manner and can guide said vapor downwards through the filter device 15 and to the fan device 7.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Cooking system
2 Control device
3 Extractor device
4 Stovetop device
5 Vapor screen device
6 Suction opening
7 Fan device
8 Placement device
9 Cookware
10 Heating device
11 Operating position
12 Operating position
13 Extension height
14 Extension height
15 Filter device
16 Transmitting/receiving device
17 Communications device
18 Diameter
19 Height
20 Operating device
21 Intermediate position
21 Countertop

1. A cooking system, comprising:
at least one control device;
at least one extractor device;
at least one cookware item; and
at least one stovetop device,
wherein the at least one extractor device comprises at least one movablevapor screen device having at least one suction opening in operative connection with at least one fan device,
wherein the at least one stovetop device comprises at least one placement device configured to place cookware and at least one heating device configured to heat cookware,
wherein the at least one movable vapor screen device is movable to at least two operating positions with at least one different extension height in each case,
wherein the at least one cookware item comprises at least one transmitting/receiving device configured to transmit at least one signal with at least one identification signature to at least the control device, by which the at least one cookware item is identifiable,
wherein the at least one control device has a communications device,
wherein the at least one control device is configured to determine an identity of the at least one cookware item by the at least one identification signature, and
wherein the at least one control device is configured to automatically move the at least one movable vapor screen device to the operating position assigned to the identity of the at least one cookware item and move the at least one movable vapor screen device to the operating position assigned to the identified at least one cookware item.

2. The cooking system of claim 1, wherein at least one operating position assigned to the identity of at least one cookware item is stored in the at least one control device.

3. The cooking system of claim 1, wherein at least one operating position assigned to the identity of at least one cookware item is settable by a user.

4. The cooking system of claim 1, wherein an operating position which is repeatedly set by a user when using a particular cookware item is automatically assigned to the identity of the at least one cookware item.

5. The cooking system of claim 1, wherein the at least one control device is configured to identify the at least one cookware item from at least one parameter of the at least one cookware item.

6. The cooking system of claim 5, wherein the parameter of a cookware item comprises:
a diameter of a bottom, and/or
a diameter and/or a circumference of a wall, and/or
a height of the at least one cookware item, and/or
a shape of the at least one cookware item, and/or
a frequency of use.

7. The cooking system of claim 1, wherein a power consumed by at least one heating device is determinable such that the at least one control device is configured to draw conclusions about the identity of at least one cookware item from at least the power consumed.

8. A method for operating a cooking system, comprising:
providing the cooking system, which comprises:
at least one control device,
at least one extractor device comprising at least one movable vapor screen device having at least one suction opening in operative connection with at least one fan device and being movable to at least two operating positions with at least one different extension height in each case,
at least one cookware item, and
at least one stovetop device comprising at least one placement device configured to place cookware and at least one heating device configured to heat cookware; and
moving the at least one movable vapor screen device to the operating position assigned to an identity of the at least one cookware item.

9. The method of claim 8, wherein the at least one cookware item comprises at least one transmitting/receiving device configured to transmit at least one signal with at least one identification signature to the at least the control device, by which the at least one cookware item is identifiable,
wherein the at least one control device has a communications device, and
wherein the at least one cookware item transmits at least one signal with at least one identification signature to the at least one control device, and the at least one control device identifies the at least one cookware item by the at least one identification signature.

10. The method of claim 8, wherein the at least one control device identifies the at least one cookware item by at least one recipe sequence program.

11. The method of claim 8, wherein the at least one control device draws conclusions about the identity of the at least one cookware item from at least one parameter of the at least one cookware item.

12. The method of claim 11, wherein the parameter of the at least one cookware item comprises:
a diameter of a bottom, and/or
a diameter and/or a circumference of a wall, and/or
a height of the at least one cookware item, and/or
a shape of the at least one cookware item, and/or
a frequency of use.

13. The method of claim 8, wherein the at least one control device and/or the at least one stovetop device determines a power consumed by at least one heating device, and the at least one control device draws conclusions about the identity of at least one cookware item from at least the power consumed.

14. The method of claim 8, wherein the at least one movable vapor screen device is moved to an intermediate position when the identity of the at least one cookware item cannot be clearly determined.
